(19) United States
(12) Patent Application Publication
(10) Pub. No.: US 2005/0135368 A1
(43) Pub. Date: Jun. 23, 2005

(54) Stream data receiving apparatus

(75) Inventor: Hiroshi Nakamura, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/992,600

(22) Filed: Nov. 19, 2004

(30) Foreign Application Priority Data
Nov. 19, 2003 (JP) P2003-389732

(51) Int. Cl. H04L 12/28

(52) U.S. Cl. 370/392; 370/503

(57) ABSTRACT

A stream data receiving apparatus includes: a data receiving unit that receives a plurality of packets; a first temporary storage unit that temporarily stores the plurality of packets; a time information detection unit that detects a first time information by extracting a first time information packet from the plurality of packets and detects a second time information by extracting a second time information packet from the plurality of packets; a data amount calculation unit that calculates data amount of packets received between the first time information packet and the second time information packet; and a time stamp appending unit that appends a time stamp to each of the packets received between the first time information packet the said second time information packet, based on the first time information, the second time information and the data amount.

The present disclosure relates to the subject matter contained in Japanese Patent Application No. 2003-389732 filed on Nov. 19, 2003, which is incorporated herein by reference in its entirety.

### BACKGROUND OF THE INVENTION

1. Field of the Invention

The present invention relates to a stream data receiving apparatus for receiving the stream data.

2. Description of the Related Art

Conventionally, in digital CS (Communications Satellite) broadcasting or digital BS (Broadcasting Satellite) broadcasting, an AV signal for broadcasting is encoded by the MPEG (Moving Picture Experts Group) 2 method and multiplexed in time division to generate an MPEG 2 transport stream (hereinafter referred to as MPEG2-TS) to be distributed as data.

The MPEG2-TS consists of a PES (Packetized Elementary Stream) packet of variable length produced by dividing video data or audio data into meaningful units. A header part of the PES packet records the kind of stream, length of packet, and-time information such as PTS (Present Time Stamp) indicating the reference time and DTS (Decode Time Stamp) indicating the decoding time.

In the MPEG2-TS, the PES packet is further divided into TS (Transport Stream) packets having a fixed length of 188 bytes, and distributed via a transmission path, as shown in FIG. 1. Each TS packet has a PID (Packet Identification) value for distinguishing the packet information divided from the PES packet for each PES packet, whereby the receiving side reproduces the PES packet based on the PID value in the received TS packet.

In the TS packets, a PCR (Program Clock Reference) indicating the reference time information is appended. The PCR is the time stamp for synchronizing an STC (System Time Clock) within the transmitter for transmitting the TS packet and an STC within the receiver for receiving the transmitted TS packet, and placed within the MPEG2-TS at every 100 milliseconds or less. More specifically, the PCR may be appended to the existent TS packet, or to the MPEG2-TS by placing the TS packet (PCR packet) dedicated for PCR between packets.

Generally, in the data transmission with the MPEG system, it is required that a delay time from the encoder input on the transmitting side to the decoder output on the receiving side is constant, that is, a fixed delay system is maintained. Accordingly, in the BS digital broadcasting or CS digital broadcasting system in which there are no variation factors regarding the data transmission delay, the receiver extracts the PCR from the MPEG2-TS transmitted from the transmitter, regenerates the STC based on the extracted PCR, and decodes, reproduce and displays the packet at the times indicated by the PTS and DTS in each PES packet with reference to the regenerated STC.

However, in the system such as the Internet in which the data transmission delay time is not constant but varies irregularly, that is, an asynchronous communication network in which there is necessarily a delay fluctuation, the STC on the receiver side is not represented correctly, causing several problems with the skewed output to degrade the reproduced image.

In order to solve these problems, a solution has been offered in which a buffer is prepared at the former stage of a decoder to adjust the transfer rate to the decoder in accordance with the received PCR value to absorb the delay fluctuation (e.g., refer to JP-A-11-177653).

Also, a method has been offered in which a time error modification device is provided on the receiver side to absorb the delay fluctuation, employing the time error modification device (e.g., refer to JP-A-2002-152273).

### SUMMARY OF THE INVENTION

The buffer disposed at the former stage of the decoder is employed for (1) regenerating the transmission timing in the fixed delay system, and (2) absorbing the delay fluctuation that occurs due to transmission of these two purposes, the buffer needs to have a large storage capacity to “absorb the delay fluctuation that occurs due to transmission” of (2). In the system such as the Internet in which the data transmission delay time is not constant but varies irregularly, that is, an asynchronous communication network in which there is necessarily a delay fluctuation, as described above, an excessively large delay may be caused, whereby the buffer having a quite large storage area must be provided at the former stage of the decoder. That is, it is required to prepare the buffer having a large storage area to “absorb the delay fluctuation that occurs due to transmission”.

With the above configuration, the decoder cannot employ the buffer at the former stage as the storage area, whereby another buffer having a larger storage area must be separately prepared within the decoder to meet various uses of the decoder. That is, with the conventional configuration, each of two buffers provided in the decoder and at the former stage of the decoder needed a large storage capacity to disable the efficient use of the storage area.

It is one of objects of the invention to solve a problem that each of two buffers provided in the decoder and at the former stage of the decoder needs a large storage capacity to disable the efficient use of the storage area.

According to a first aspect of the invention, there is provided a stream data receiving apparatus including: a data receiving unit that receives a plurality of packets; a first temporary storage unit that temporarily stores the plurality of packets: a time information detection unit that detects a first time information by extracting a first time information packet from the plurality of packets and detects a second time information by extracting a second time information packet from the plurality of packets; a data amount calculation unit that calculates data amount of packets received between the first time information packet and the second time information packet; and a time stamp appending unit that appends a time stamp to each of the packets received between the first time information packet the said second time information packet, based on the first time information, the second time information and the data amount.

According to a second aspect of the invention, there is provided a stream data receiving method including: receiving a plurality of packets; temporarily stores the plurality of packets; detecting a first time information by extracting a first time information packet from the plurality of packets; detecting a second time information by extracting a second time information packet from the plurality of packets; calculating data amount of packets received between the first time information packet and the second time information packet; and appending a time stamp to each of the packets received between the first time information packet the said second time information packet, based on the first time information, the second time information and the data amount.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic diagram showing the relationship between TS packet and PES packet;

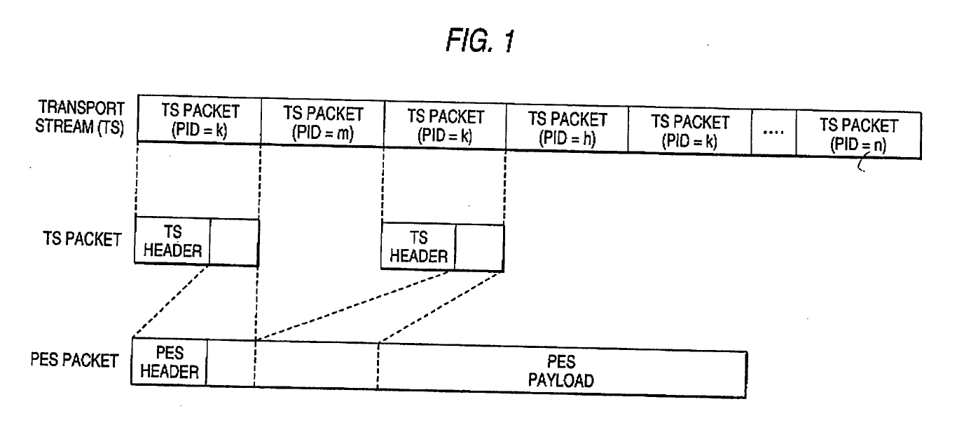

FIG. 2 is a block diagram showing the overall configuration of a stream data communication system according to a first embodiment of the invention;

FIG. 3 is a block diagram showing the details of a stream data receiving apparatus according to the first embodiment;

FIG. 4A is a schematic diagram showing an example of packet train to be transmitted or received, and FIG. 4B is a schematic diagram showing how the time stamp is appended;

FIG. 5 is a graph showing an example of transmission time and transmission data amount; and

FIG. 6 is a block diagram showing the overall configuration of a stream data communication system according to a second embodiment of the invention.

### DETAILED DESCRIPTION OF THE PREFERRED EMBODIMENTS

The preferred embodiments of a stream data receiving apparatus for receiving the stream data according to the present invention will be described below with reference to the accompanying drawings.

### First Embodiment

Herein, a first embodiment of the stream data receiving apparatus according to the invention will be described below.

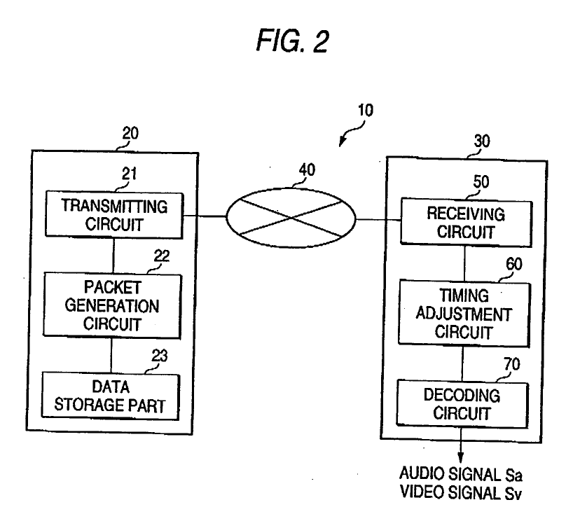

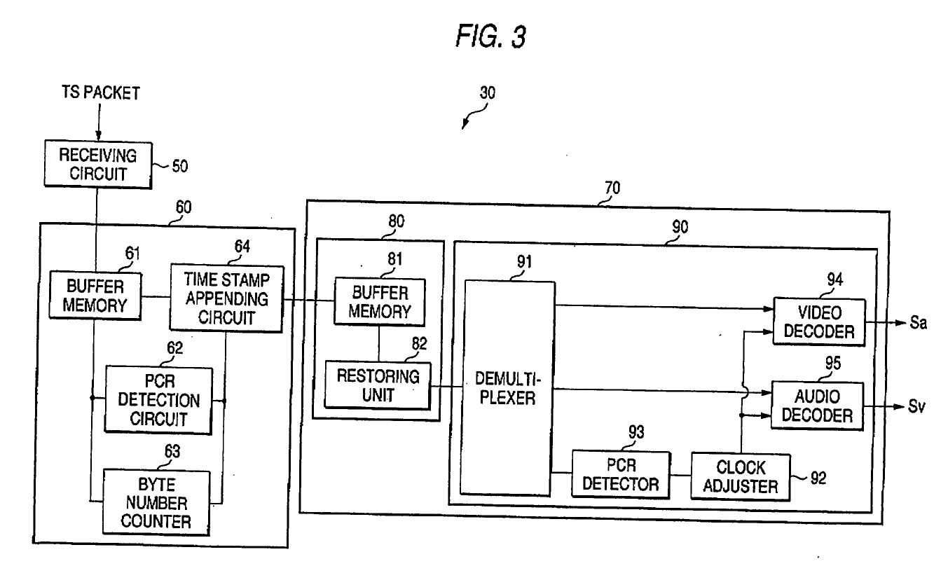

FIG. 2 is a block diagram showing the overall configuration of a stream data communication system having the stream data receiving apparatus of the first embodiment, and FIG. 3 is a block diagram showing the details of the stream data receiving apparatus of the first embodiment.

The stream data communication system 10 of the first embodiment includes a stream data transmitting apparatus 20, and a stream data receiving apparatus 30 connected communicably via the Internet 40, which is an asynchronous communication network, to the stream data transmitting apparatus 20, as shown in FIG. 2. The stream data communication system 10 is the system for making the data communication by transmitting the stream data (MPEG2-TS) composed of a plurality of TS packets from the stream data transmitting apparatus 20 to the stream data receiving apparatus 30. Herein, the TS packet is produced by dividing the PES packet encoded for each unit into predetermined length. Each TS packet has a PID (Packet Identification) value for distinguishing one PES packet from another, whereby the receiving side reproduces the PES packet, based on the PID value of the received TS packet.

The stream data transmitting apparatus 20 mainly includes a transmitting circuit 21 for transmitting the stream data composed of a plurality of packets, a packet generation circuit 22 for generating the stream data, and a data storage part 23 for storing the data on which the stream data is based.

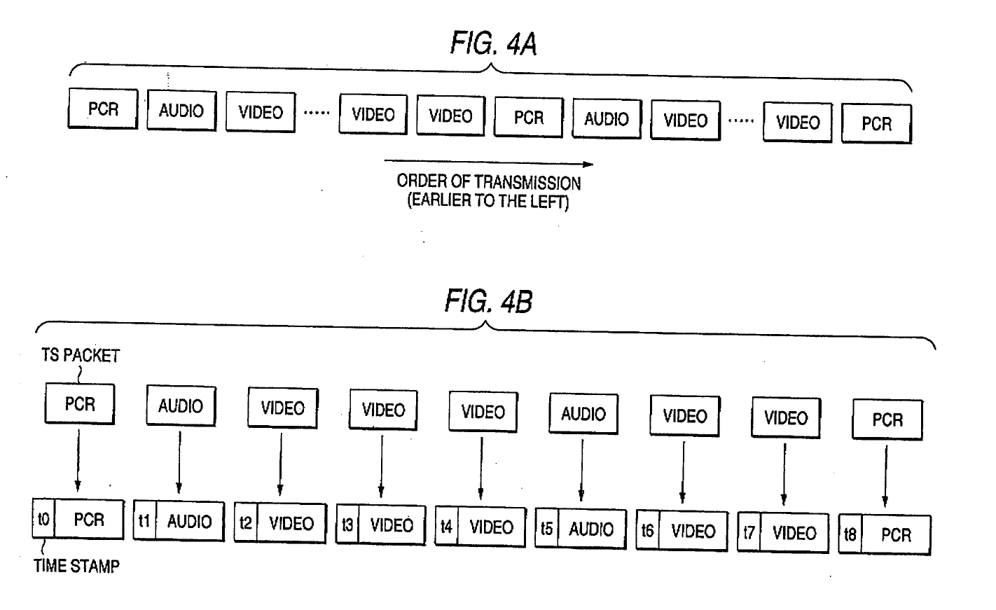

The data storage part 23 is the storage device for storing the data such as video data or audio data, such as a hard disk drive or an optical magnetic disk drive. The packet generation circuit 22 reads the data such as video data or audio data from the data storage part 23, and encodes and multiplexes the read data to produce the stream data composed of a plurality of TS packets such as video packets or audio packets (e.g., see FIG. 4A). And the generated stream data is transmitted from the transmitting circuit 21 as the communication interface via the Internet 40 to the stream data receiving apparatus 30.

In a row of TS packets transmitted from the transmitting circuit 21, a PCR packet is inserted into the stream data at a regular interval (e.g., one packet per 100 ms). The PCR packet contains the PCR that is the time stamp indicating the reference time information. The stream data receiving apparatus 30 makes the fine adjustment of the system clock (STC) within the stream data receiving apparatus 30, based on the PCR, to be synchronized with the stream data transmitting apparatus 20.

The stream data receiving apparatus 30 is the apparatus for receiving the stream data, decoding the received stream data, and reproducing the video data or audio data. The stream receiving apparatus 30 has a receiving circuit 50, a timing adjustment circuit 60, and a decoding circuit 70 for decoding the stream data.

The receiving circuit 50 is a communication interface for receiving the stream data transmitted from the stream data transmitting apparatus 20 via the Internet 40, in which the received stream data, namely, the received TS packets, are output to the timing adjustment circuit 60 in the receiving order. In the first embodiment, the receiving circuit 50 serves as a data receiving unit that receives a plurality of packets.

The timing adjustment circuit 60 adjusts the timing by temporarily holding the TS packet, and appends the predetermined time stamp to each received TS packet, and includes a buffer memory 61, a PCR detection circuit 62, a byte number counter 63, and a time stamp appending circuit 64, as shown in FIG. 3.

The buffer memory 61 is a temporary storage unit for buffering the received TS packets sequentially. The buffer memory 61 temporarily buffers the TS packet received for a period from when one PCR packet is received till the next PCR packet is received, in which the storage capacity of the buffer memory 61 is set to cover a PCR packet interval (e.g., 100 ms). In the first embodiment, the buffer memory 61 serves as a first temporary unit that temporarily stores the plurality of packets.

The PCR detection circuit 62 is a PCR packet monitor for confirming whether or not the PCR packet arrives in the buffer memory 61. If the PCR detection circuit 62 detects the PCR packet to arrive in the buffer memory 61, it extracts the ECR in the PCR packet to output a trigger signal or the like indicating that the PCR arrives in the byte number counter 63 and output the extracted PCR to the time stamp appending circuit 64, and notifies the byte number counter 63 and the time stamp appending circuit 64-that the PCR packet arrives in the buffer memory 61. That is, the PCR detection circuit 62 functions as a time information detecting part for detecting the time information by detecting the PCR. In the first embodiment, the PCR detection circuit 62 serves as a time information detection unit that detects a first time information by extracting a first time information packet from the plurality of packets and detects a second time information by extracting a second time information packet from the plurality of packets.

The byte number counter 63 is a data amount calculating part for counting the total amount of data from the time when the PCR packet is received till the next PCR packet is received. The byte number counter 63, upon receiving a trigger signal from the PCR detection circuit 62, monitors the buffer memory 61, and integrates the number of bytes (i.e., amount of data) of the TS packets temporarily held in the buffer memory 61. And the byte number counter 63, upon receiving the next trigger signal, suspends to integrate the number of bytes based on the previous trigger signal, and outputs the data amount information based on the integral number of bytes to the time stamp appending circuit 64. And the byte number counter 63 resets the integral number of bytes, and integrates again the number of bytes of the TS packets temporarily held in the buffer memory 61 since the next trigger signal is received. In the first embodiment, the byte number counter 63 serves as a data amount calculation unit that calculates data amount of packets received between the first time information packet and the second time information packet.

If the time stamp appending circuit 64 receives the PCR from the PCR detection circuit 62, and receives the data amount information from the byte number counter 63, it issues a transfer instruction to the buffer memory 61, and receives the TS packets one by one from the PCR packets accumulated in the buffer memory 61, up to the TS packet directly before the next PCT packet. And the time stamp appending circuit 64 appends the new time stamp to the TS packets (including the PCR packet) that are sequentially sent from the buffer memory 61, and outputs the TS packets to the decoding circuit 70, as shown in FIG. 4B. In the first embodiment, the time stamp appending circuit 64 serves as a time stamp appending unit that appends a time stamp to each of the packets received between the first time information packet the said second time information packet, based on the first time information, the second time information and the data amount.

Herein, the time stamp appended by the time stamp appending circuit 64 will be described below.

The time stamp appending circuit 64 receives (a) PCR (first PCR) as the time information corresponding to the previous PCR packet (first PR packet), (b) PCR (second PCR) as the time information corresponding to the next PCR packet (second PCR packet), and (c) the data amount information of TS packets temporarily stored in the buffer memory 61 for a period from when the first PCR packet arrives in the buffer memory 61 till the second PCR packet arrives in the buffer memory 61 at the time of issuing a transfer instruction to the buffer memory 61.

The time stamp appending circuit 64 first of all appends the time stamp corresponding to the first time information indicated by the first PCR to the first PCR packet. And for the TS packets received between the first PCR packet and the second PCR packet, the time stamp is assigned as the time conforming to the data amount of TS packets received between the first time information indicated by the first PCR and the second time information indicated by the second PCR. And the time stamp appending circuit 64 appends the time stamp corresponding to the second time information indicated by the second PCR to the second PCR packet.

Herein, the time stamp conforming to the data amount is assigned in accordance with the following equation, for example.

$$\begin{matrix}\begin{matrix}{t}_{n} = {t}_{0} + \frac{{t}_{k + 1} - {t}_{0}}{k} \cdot n & & ( 1 \leq n \leq k )\end{matrix} \\ where \text{:}\end{matrix} \qquad equation ( 1 )$$

k is the number of packets received between the first PCR packet and the second PCR packet;
t₀ is the first time information;
tₖ₊₁ is the second time information; and
tₙ is the time information appended to the n-th received packet after receiving the first time information packet.

In the case where the equation (1) is satisfied, the number of packets is used as the data amount, and the time between the first time information and the second time information is divided in accordance with the number of packets received between the first PCR packet and the second PCR packet to obtain a time interval between TS packets, thereby appending the time stamp to the TS packets sequentially in accordance with the time interval.

As described above, the time stamp appending circuit 64 appends the time stamp to all the TS packets received by the above method, whereby the TS packets with the time stamp appended are sent to the decoding circuit 70. That is, the timing adjustment circuit 60 comprising the time stamp appending circuit 64 temporarily holds the TS packets for a period from when the PCR packet is received in the buffer memory 61 till the next PCR packet is received to absorb a delay fluctuation that occurs due to transmission, and preserves a fixed delay system in which the reproduction timing is included in the time indicated by the time stamp by appending the time stamp to all the TS packets.

The decoding circuit 70 reproduces the audio data or video data, based on a plurality of received TS packets. The decoding circuit 70 has a timing restoring circuit 80 for restoring the reproduction timing, and a decoder 90 for decoding the TS packet to reproduce the audio data or video data.

The timing restoring circuit 80 restores the reproduction timing, namely, the transmission delay between TS packets transmitted from. the stream data transmitting apparatus 30, and maintains the fixed delay system, and includes a buffer memory 81 and a restoring unit 82.

The buffer memory 81 is a temporary storage unit for temporarily storing the TS packet output from the timing adjustment circuit 60. The buffer memory 81 has a storage capacity required to maintain the transmission timing of TS packet by the stream data transmitting apparatus 30. In the first embodiment, the buffer memory 81 serves as a second temporary storage unit that temporarily stores the packets output from the time stamp appending unit.

The restoring unit 82 outputs the TS packets accumulated in the buffer memory 81 to the decoder 90 at the time described in the time stamp appended to each TS packet by the time stamp appending circuit 64. That is, the restoring unit 82 inputs the TS packet into the decoder 90, while keeping the transmission timing from the stream data transmitting apparatus 30 by shifting the output timing to the decoder 90 in accordance with the time stamp appended to each TS packet. The restoring unit 82 deletes the time stamp appended to each TS packet at the time of outputting to the decoder 90. In the first embodiment, the restoring unit 82 serves as a timing restoring unit that outputs the packets stored in the second temporary storage unit to the decoder in accordance with the time stamp.

The decoder 90 decodes the TS packet to reproduce the audio data or video data for output. The decoder 90 has a demultiplexer 91, a PCR detector 92, a clock adjuster 93, a video decoder 94, and an audio decoder 95.

The demultiplexer 91 classifies the TS packets into kinds, according to the PID value, and allocates them to the corresponding decoders. Herein, the TS packet corresponding to the video data is output to the video decoder 94, the TS packet corresponding to the audio data is output to the audio decoder 95, and the PCR packet in the TS packet is output to the PCR detector 92.

The PCR detector 92 is the detector for extracting the PCR in the PCR packet. And the clock adjuster 93 adjusts the system time clock (STC) within the stream data receiving apparatus 30 in accordance with the time information in the PCR extracted by the PCR detector 92 to synchronize the time information within the stream data receiving apparatus 30 with the stream data transmitting apparatus 20. The clock adjuster 93 is composed of a PLL circuit, for example.

The video decoder 94 decodes the TS packet corresponding to the video data output from the demultiplexer 91 to produce the video data Sv, and the audio decoder 95 decodes the TS packet corresponding to the audio data output from the demultiplexer 91 to produce the audio data Sa. The video data Sv and the audio data Sa reproduced by the video decoder 94 and the audio decoder 95 are passed to the output devices such as a display, an amplifier and a speaker, not shown, for reproduction.

With the configuration, the stream data transmitted from the stream data transmitting apparatus 20 is received by the stream data receiving apparatus 30 to reproduce the audio data or video data.

As described above, the stream data receiving apparatus 30 of the first embodiment includes the receiving circuit 50 as a data receiving unit for receiving a plurality of packets, the memory buffer 61 as a first temporary storage unit for temporarily storing the plurality of packets, the PCR detection circuit 62 as a time information detection unit for detecting the first PCR (first time information) by extracting a first PCR packet (first time information packet) from the plurality of TS packets and detecting the second PCR (second time information) by extracting a second PCR packet (second time information packet) from the plurality of packets, the byte number counter 63 as a data amount calculation unit for calculating the data amount of TS packets received between the first PCR packet and the second PCR packet, and the time stamp appending circuit 64 for appending the time stamp to each of TS packets received between the first PCR packet and the second PCR packet, based on the first PCR, the second PCR and the calculated data amount.

Also, the stream data receiving apparatus 30 includes the decoder 90 for performing a decoding process based on the time stamp appended to the TS packet by receiving the TS packet output from the time stamp appending circuit 64, the buffer memory 81 as a second temporary storage unit for temporarily storing the TS packet output from the time stamp appending circuit 64, and the restoring unit 82 for outputting the TS packet stored in the buffer memory 81 to the decoder 90 based on the time stamp.

In the first embodiment, the TS packets are temporarily held in the buffer memory 61 to append the time stamp, the buffer memory having a storage capacity of temporarily storing only the amount of data from when the PCR packet is received till the next PCR packet is received is provided to absorb the delay fluctuation that occurs due to transmission. Moreover, since the reproduction timing is recorded in the time stamp by temporarily appending the time stanp to all the packets, the data buffer for establishing the reproduction timing is effected, separately from the buffer memory 61 for absorbing the delay fluctuation, specifically, in the buffer memory 81 on the side of the decoding circuit 70.

Accordingly, the buffer memory 81 may be employed as a memory area of the decoder 90 provided within the same decoding circuit 70, whereby the auxiliary storage area of the decoder generally requiring a lot of memory area can be secured in the same decoding circuit.

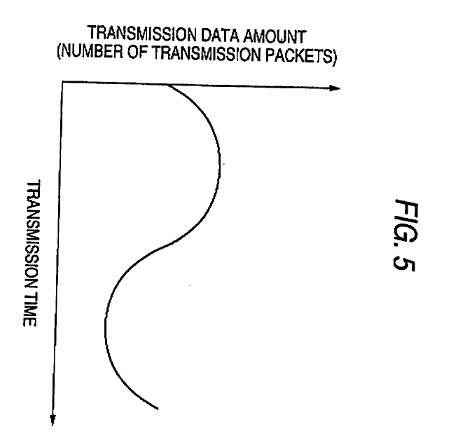

In the first embodiment, the time stamp appending circuit 64 appends the time stamp to each of the TS packets in accordance with the equation (1), but the invention is not limited to the embodiment, Generally, since the TS packets are mostly transmitted so that the data amount becomes sparse or dense according to the time, as shown in FIG. 5, the reproduction timing may not be possibly regenerated, if the time stamp is evenly allocated in accordance with the equation (1). In view of these circumstances., the time stamp appending circuit 64 may append the time stamp in accordance with the receiving timing of the TS packet by the receiving circuit 50, namely, the arrival timing to the buffer memory 61, for example.

### Second Embodiment

Herein, a second embodiment of the stream data receiving apparatus according to the invention will be described below.

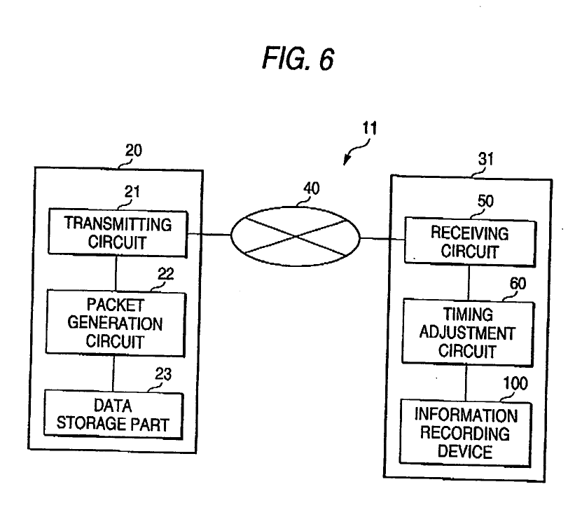

FIG. 6 is a block diagram showing the overall configuration of the stream data comunication system equipped with the stream data receiving apparatus of the second embodiment.

In the following explanation, the same parts of the first embodiment are not described here to avoid duplicate description.

The stream data communication system 11 of the second embodiment includes a stream data transmitting apparatus 20, a stream data receiving apparatus 31 connected to be communicable with the stream data transmitting apparatus 20 via the Internet 40 that is an asynchronous communication network, as shown in FIG. 6. Herein, the configuration of the stream data transmitting apparatus 10 is the same as described in the first embodiment.

The stream data receiving apparatus 31 has an information recording device 100, which is a replacement of the decoding circuit 70 of the stream data receiving apparatus 30 of the first embodiment. The other configuration is the same. That is, the stream data receiving apparatus 31 receives a plurality of TS packets in the receiving circuit 50, in which the received TS packet is sent to the timing adjusting circuit 60. And inside the timing adjusting circuit 60, the plurality of TS packets are temporarily stored in the buffer memory 61. And the PCR detection circuit 62 detects the first PCR (first time information) by extracting a first PCR packet (first time information packet) from the plurality of TS packets and detects the second PCR (second time information) by extracting a second PCR packet (second time information packet) from the plurality of packets. And the byte number counter 63 calculates the data amount of TS packets received between the first PCR packet and the second PCR packet, and the time stamp appending circuit 64 appends the time stamp to each of TS packets received between the first PCR packet and the second PCR packet, based on the first PCR, the second PCR and the calculated data amount. In the second embodiment, the information recording device 100 serves as an information recording unit that receives and records the packets output from the time stamp appending unit.

In the second embodiment, the TS packets having the time stamp appended in the timing adjusting circuit 60 are output directly to the information recording device 100. The information recording device 100 is composed of a magnetic recording apparatus such as a hard disk drive, or an optical recording apparatus for recording the information on an optical recording disk, such as CD or DVD. The information recording device 100 directly records the TS packet with the time stamp output from the timing adjusting circuit 60 in an information recording area within the information recording device 10.

In the second embodiment, since the TS packet is temporarily held in the buffer memory 61 to append the time stamp, the buffer memory having a storage capacity of temporarily storing only the amount of data from when the PCR packet is received till the next PCR packet is received is provided to absorb the delay fluctuation that occurs due to transmission. Moreover, since the reproduction timing is recorded in the time stamp by temporarily appending the time stamp to all the packets, the TS packets are recorded in the information recording device 100 by absorbing the delay fluctuation and recording the reproduction timing as the time information within the time stamp. Accordingly, when the TS packets recorded within the information recording device 100 are reproduced, for example, the reproduction timing is easily regenerated and the TS packet is reproduced at any time by employing the same decoding circuit as the decoding circuit 70 of the first embodiment.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

1. A stream data receiving apparatus comprising:
a data receiving unit that receives a plurality of packets;
a first temporary storage unit that temporarily stores the plurality of packets;
a time information detection unit that detects a first time information by extracting a first time information packet from the plurality of packets and detects a second time information by extracting a second time information packet from the plurality of packets;
a data amount calculation unit that calculates data amount of packets received between the first time information packet and the second time information packet; and
a time stamp appending unit that appends a time stamp to each of the packets received between the first time information packet the said second time information packet, based on the first time information, the second time information and the data amount.

2. The stream data receiving apparatus according to claim 1, wherein the time stamp appending unit appends the time information to each of the packets in accordance with the following equation.
$$\begin{matrix}\begin{matrix}{t}_{n} = {t}_{0} + \frac{{t}_{k + 1} - {t}_{0}}{k} \cdot n & & ( 1 \leq n \leq k )\end{matrix} \\ where \text{:}\end{matrix}$$
k is the number of packets received between the first time information packet and the second time information packet;
t₀ is the first time information;
tₖ₊₁ is the second time information; and
tₙ is the time information appended to the n-th received packet after receiving the first time information packet.

3. The stream data receiving apparatus according to claim 1, wherein the time stamp appending unit appends the time stamp in accordance with a receiving timing of each of the packets in the data receiving unit.

4. The stream data receiving apparatus according to claim 1, further comprising a decoding circuit including a decoder that receives the packets output from the time stamp appending unit and performs a decoding process based on the time information appended to each of the received packets.

5. The stream data receiving apparatus according to claim 4, wherein the decoding circuit further includes:
a second temporary storage unit that temporarily stores the packets output from the time stamp appending unit; and
a timing restoring unit that outputs the packets stored in the second temporary storage unit to the decoder in accordance with the time stamp.

6. The stream data receiving apparatus according to claim 1, further comprising an information recording unit that receives and records the packets output from the time stamp appending unit.

7. A stream data receiving method comprising:
receiving a plurality of packets:
temporarily stores the plurality of packets;
detecting a first time information by extracting a first time information packet from the plurality of packets;
detecting a second time information by extracting a second time information packet from the plurality of packets;
calculating data amount of packets received between the first time information packet and the second time information packet; and
appending a time stamp to each of the packets received between the first time information packet the said second time information packet, based on the first time information, the second time information and the data amount.
